(19) United States
(12) Patent Application Publication
(10) Pub. No.: US 2023/0168898 A1
(43) Pub. Date: Jun. 1, 2023

(54) METHODS AND APPARATUS TO SCHEDULE PARALLEL INSTRUCTIONS USING HYBRID CORES

(71) Applicant: Intel Corporation, Santa Clara, CA (US)

(72) Inventors: Yuan Chen, Shanghai (CN); Junyong Ding, Shanghai (CN); Mohammad Haghighat, San Jose, CA (US)

(21) Appl. No.: 18/159,666

(22) Filed: Jan. 25, 2023

Related U.S. Application Data
(63) Continuation of application No. PCT/CN2022/142329, filed on Dec. 27, 2022.

(51) Int. Cl. G06F 9/38

(52) U.S. Cl. CPC G06F 9/3885; G06F 9/3851

(57) ABSTRACT

Methods, apparatus, systems, and articles of manufacture to schedule parallel instructions using hybrid cores are disclosed. An example apparatus includes thread processing circuitry to split a first thread of the parallel threads into partitions; scheduling circuitry to: select (a) a first core to execute a first partition of the partitions and (b) a second core different than the first core to execute a second partition of the partitions; and generate an execution schedule based on the selection, the interface circuitry to transmit the execution schedule to a device that schedules instructions on the first and second core.

### RELATED APPLICATION

This patent arises from a continuation of International Patent Application No. PCT/CN2022/142329 which was filed on Dec. 27, 2022. International Patent Application No. PCT/CN2022/142329 is hereby incorporated herein by reference in its entirety. Priority to International Patent Application No. PCT/CN2022/142329 is hereby claimed.

### FIELD OF THE DISCLOSURE

This disclosure relates generally to computing devices and, more particularly, to methods and apparatus to schedule parallel instructions using hybrid cores.

### BACKGROUND

In recent years, computing devices have been implemented with different types of cores. For example, a computing device can be implemented with one or more high performance cores (e.g., also referred to as performance cores or big cores) and one or more efficient cores (e.g., also referred to as little cores or atoms). Performance cores are generally faster and/or more capable of executing complex tasks, but require a large amount of resources (e.g., physical space, processor resources, memory, etc.) to implement. Efficient cores are generally slower, but utilize a small amount of resources. Hybrid cores refer to the use of both performance cores and efficient cores.

### BRIEF DESCRIPTION OF THE DRAWINGS

FIG. 1 is an example computing device for executing one or more workloads described in conjunction with examples disclosed herein.

FIG. 2A is a block diagram of an example instruction processing circuitry of FIG. 1.

FIG. 2B is a block diagram of an example streamed threading circuitry of FIG. 1.

FIGS. 3A and 3B illustrates an example of the benefits of examples disclosed herein.

FIG. 4 illustrates an example of a streamed threading process.

FIGS. 5-8 are flowcharts representative of example machine readable instructions and/or example operations that may be executed by example processor circuitry to implement the computing device of FIGS. 1 and/or 2A.

FIG. 9 is a block diagram of an example processing platform including processor circuitry structured to execute the example machine readable instructions and/or the example operations of FIGS. 5-8 to implement the computing device of FIGS. 1-2B.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 5-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Software services may distribute instructions from the cloud to a computing device to be executed by the computing device. In some examples, the instructions are parallel instructions (e.g., a task with multiple threads that can be executed independently in parallel). In this manner, if the computing device has multiple cores, the multiple cores can execute the threads in parallel, thereby resulting in a more efficient and/or faster instruction execution.

In some examples, a computing device may have different types of cores (e.g., one or more types of high performance cores, one or more types of efficient cores, one or more types of accelerators, etc.). In such examples, the computing device utilizes the cores to execute the different parallel threads. However, because the different cores utilize different amounts of resources, the threads that are executed by performance cores may be completed sooner (e.g., 1.6 times sooner, 2.6 times sooner, etc.) than the threads executed on efficient cores, thereby leading to an imbalanced and/or inefficient parallel workload execution across the hybrid cores. However, software services are not aware of the hardware configuration (e.g., how many cores and/or which type of cores) of the computing system that is receiving the parallel instructions because computing devices have different configurations. Accordingly, the software services cannot generate a recommended schedule for executing the parallel instruction to further increase speed and/or efficiency of execution.

Examples disclosed herein increase the efficiency and/or speed of parallel instruction execution by dynamically breaking, decomposing, grouping, and/or sectioning parallel threads into smaller partitions (also referred to as portion, sub threads, subtasks, etc.) and scheduling the partitions across the cores of the computing device according to the configuration of the computing device. By breaking up a thread into two or more partitions, the partitions can be scheduled across the cores according to the complexity of the partitions and the configurations of the cores to reduce the amount of time needed to complete the threads and increase the efficiency of the execution by ensuring that cores are not idle while other cores are working. Additionally, examples disclosed herein utilize streamed threads to support thread pipelining with dreaming data form the operating system (OS) level for increased speed and efficiency.

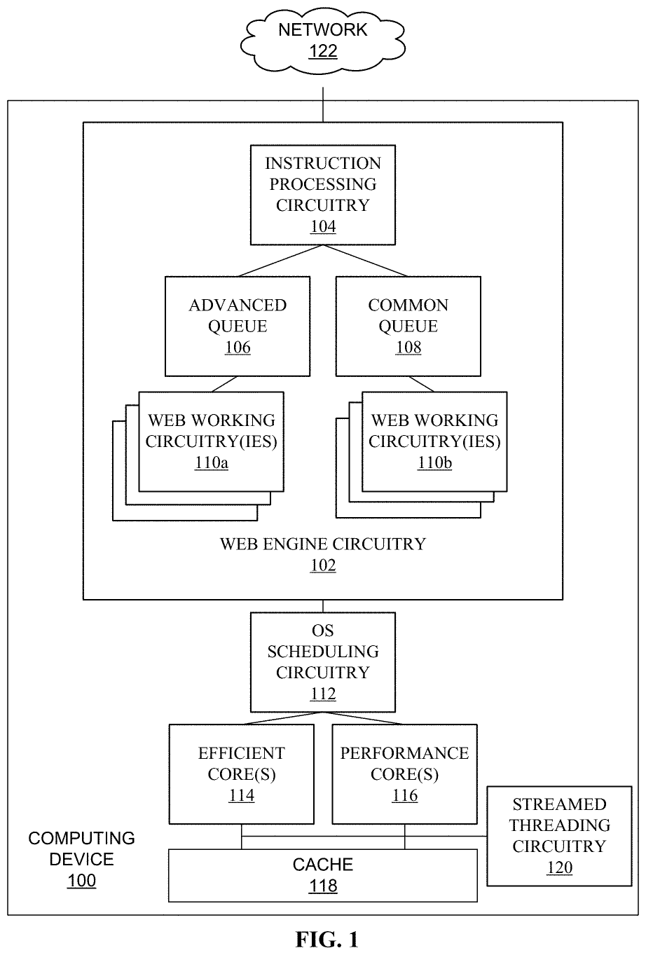

FIG. 1 illustrates an example computing device 100 for implementing workloads locally and/or using cloud-based resources. The example computing device 100 includes example web engine circuitry 102. The example web engine circuitry 102 includes example instructions processing circuitry 104, an example advanced queue 106, an example common queue 108, example web working circuitries 110a, and example web working circuitries 110b. The example computing device 100 further includes OS scheduling circuitry 112, example efficient cores 114 (e.g., E cores), example performance cores 116 (e.g., P cores), example cache 118, and example streamed threading circuitry 120. FIG. 1 further includes an example network 122.

The example computing device 100 of FIG. 1 is a device capable of executing parallel instructions obtained via the example network 122 (e.g., from a cloud-based service/server, another computing device, etc.). The example computing device 100 may be a server, a processing device, a mobile device (e.g., a tablet, a smartphone, etc.), a personal computer, an edge device, a fog device, a client device, a smart device (e.g., smart phone, smart appliance, etc.), and/or any other computing device capable of executing instructions. The example computing device 100 includes the example web engine circuitry 102 to receive parallel instructions and generate a recommended execution schedule for the parallel instructions.

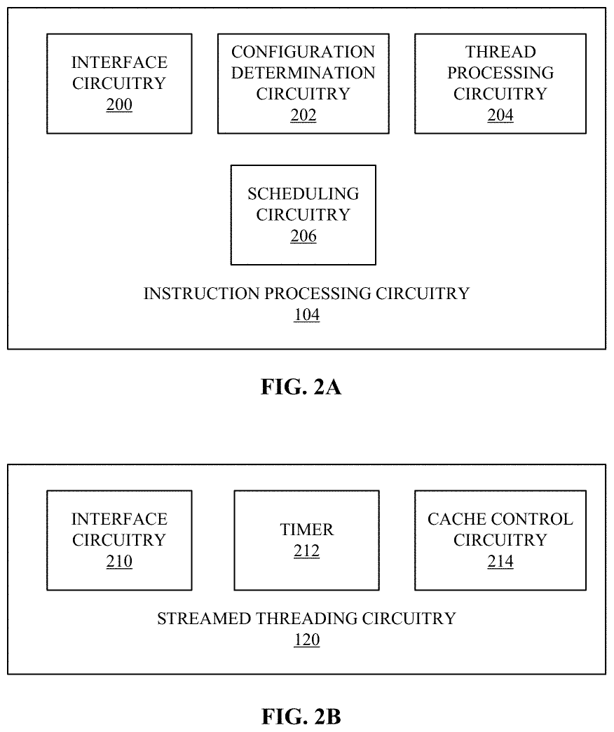

The example web engine circuitry 102 of FIG. 1 includes the example instruction processing circuitry 104. The example instruction processing circuitry 104 obtains parallel threads via the example network 122. After parallel instructions are obtained, the example instruction processing circuitry 104 breaks the threads into two or more partitions and schedules the partitions based on the complexity of the partitions, the configuration of the cores 114, 116, etc., while respecting order of the partitions of a thread. For example, although each thread can be executed in parallel, some (or all) partitions may require serial operation. Accordingly, when a thread is broken into two or more partitions, the partitions may need to be executed in order. However, the partitions of a same thread can be scheduled on different cores, to increase the efficiency and/or speed of workload execution. In some examples, the instruction processing circuitry 104 generates a schedule in software (e.g., using runtime software) or accelerated through hardware instructions. The example instruction processing circuitry 104 is further described below in conjunction with FIG. 2A.

After the instruction processing circuitry 104 of FIG. 2 generates the instruction schedule, the processing circuitry 104 loads the partitions in the example queues 106, 108. The advanced queue 106 stores partitions scheduled for execution via the P cores(s) 116 based on the generated instruction schedule and the common queue 108 stores partitions scheduled for execution via the E core(s) 114 based on the generated instruction schedule. The queues 106, 108 may be implemented using storage, a buffer, memory, a datastore, and/or any other type of data storage technology. The web working circuitries 110a, 110b facilitate the use of web content to run scripts in background threads. In some examples, the web working circuitries 110a, 110b are executed using JavaScript that runs in the background, independently of other scripts, without affecting performance of the page. In some examples, the web working circuitry 110a, 110b sends the schedule suggestion (e.g., based on the order of the queues) to the example OS scheduling circuitry 112. In some examples, the instruction processing circuitry 104 sends the suggestion to the OS scheduling circuitry 112. If a processor of the computing device 100 has specified instructions for spawning a new partition, the instructions can be utilized. If the runtime is equipped with a task queue (e.g., that the OS is not aware of), then the execution of the instruction will be yielded to a runtime scheduler (e.g., the OS scheduling circuitry 214) via a mechanism which can be implemented using specific call or branch instructions. In some examples, hints and/or suggestions can be provided to the OS regarding the scheduling preference.

Because the OS scheduling circuitry 112 may be scheduling multiple instructions from multiple applications, the schedule is sent as a suggestion of execution. However, it may be up to the OS scheduling circuitry 112 to determine whether to use the suggested schedule or another schedule. In some examples, before making the schedule, the instruction processing circuitry 104 may transmit a request to the OS scheduling circuitry 112 to determine whether the OS scheduling circuitry 112 desires the suggestion. In this manner, the instruction processing circuitry 104 can save resources by not generating a schedule after obtaining a response from the OS scheduling circuitry 112 indicating that a scheduling suggestion is not desired at a point in time.

The OS scheduling circuitry 112 of FIG. 1 implements the parallel instructions on the example cores 114, 116 based on the schedule suggestion. If the OS scheduling circuitry 112 that the schedule suggestion cannot or should not be accomplished (e.g., due to other demands, instructions, and/or restrictions), the OS scheduling circuitry 112 may implement a portion of the suggested scheduling or none of the suggested scheduling. If the OS scheduling circuitry 112 determines that the schedule suggestion can or should be accomplished, the OS scheduling circuitry 112 forwards the portions of the threads to the example cores 114, 116 according to the generated scheduling suggestion.

The example cores 114, 116 of FIG. 1 are processing cores to execute instructions (e.g., thread(s) and/or partitions of thread(s) to execute one or more tasks). The example efficiency core(s) (e.g., also referred to as E cores, little cores, small cores, atoms, etc.) 114 may include any number and/or type of cores that more efficient (e.g., require less resources), slower, and smaller (e.g., silicon space) than the example P core(s) 116. The performance core(s) 116 (e.g., also referred to as P cores, big cores, etc.) may include any number and/or type of cores that have higher performance (e.g., require more resources), faster, and larger than the example E core(s) 116. There may be different levels of the E core(s) 114 and/or P cores(s) 116 that correspond to different performance, speed, size, etc. There may be any number of E core(s) 114 and/or P core(s) 116 implemented on the computing device 100. As described above, E core(s) 114 are also referred to as little cores and/or atoms and P core(s) 116 are also referred to as big cores.

The example cache 118 of FIG. 1 is memory (e.g., read only memory, local memory, etc.) that can store information related to execution of the parallel threads and/or partitions. For example, the cache 118 may include one or more dedicated spaces that correspond to particular threads. In this manner, even if partitions are executed by different cores 114, 116, the output of a partition can be accessed in the cache 118 to continue operation on another core.

The example streamed threading circuitry 120 of FIG. 2 implements a protocol to execute partitions in a streamed manner to increase the efficiency of thread execution. For example, the streamed threading circuitry 120 can instruct the core(s) 114 to store partially complete partition outputs to a streaming buffer in the cache 118 at one or more points in time during the execution of the partitions. In this manner, another core can access the partial information to start execution on a subsequent partition corresponding to the same thread prior to the first partition being complete, thereby increasing the speed and/or efficiency of execution. Although the streamed threading circuitry 120 is being implemented as a standalone component in FIG. 1, the streamed threading circuitry 120 may be part of one or more of the core(s) 114, 116 and/or the OS scheduling circuitry 112. The example streamed threading circuitry 120 is further described below in conjunction with FIG. 2B.

The example network 122 of FIG. 1 is a system of interconnected systems exchanging data. The example network 122 may be implemented using any type of public or private network such as, but not limited to, the Internet, a telephone network, a local area network (LAN), a cable network, and/or a wireless network. To enable communication via the network 122, the example computing device 100 includes a communication interface that enables a connection to an Ethernet, a digital subscriber line (DSL), a telephone line, a coaxial cable, any wireless connection or communication, any network communication, etc. The computing device 100 receives parallel instructions from another device via the example network 122.

FIG. 2A is a block diagram of the example instruction processing circuitry 104 of FIG. 1. The example instruction processing circuitry 104 includes example interface circuitry 200, example configuration determination circuitry 202, example thread processing circuitry 204, and example scheduling circuitry 206.

The example interface circuitry 200 of FIG. 2 obtains the parallel instructions (e.g., threads) from a device via the example network 122 of FIG. 1. Additionally, the example interface circuitry 200 stores the generated partitions into the example queues 106, 108 of FIG. 1 based on a generated schedule (e.g., which partitions to execute on the E cores 114 and P cores 116 of FIG. 1 and in what order). In some examples, the interface circuitry 200 transmits the generated schedule as a suggestion to the example OS scheduling circuitry 112 of FIG. 1.

The example configuration determination circuitry 202 of FIG. 2 determines the configuration of core 114, 116 including how many cores implemented on the example computing device 100. Additionally, the example configuration determination circuitry 202 determines the type of cores implemented on the example computing device 100. In some examples, the web engine circuitry 102 may be an application that is downloaded on the computing device 100 after the computing device 100 is created. Accordingly, the configuration determination circuitry 202 may need to only determine the configuration once (e.g., when first used).

The example thread processing circuitry 204 of FIG. 2 determines how many partitions to breakup, divide, split, partition, separate, the example threads into. The number of partitions may be based on the configuration of the cores, characteristics of the threads, and/or user/manufacturer preferences. Additionally, the example thread processing circuitry 204 can determine the complexity of the partitions. For example, the thread processing circuitry 204 can process the threads to separate the threads into complex (also referred to as computationally intensive) partitions and non-complex (also referred to as non-computationally intensive) partitions and determine the complexity of each partition so that the scheduling circuitry 206 can attempt to schedule complex partitions on the P cores 116. As described above, the P cores 116 may be able to execute complex partitions significantly faster than the E cores. Accordingly, the scheduling circuitry 206 can use the partition complexity information for scheduling, as further described below. The thread processing circuitry 204 may generate complexity levels corresponding to the different type of cores. For example, if there are just one level of performance cores and one level of efficient cores, the thread processing circuitry 204 may identify and/or label partitions as performance or efficient. However, if there are more than one level of performance cores and/or more than one level of efficient cores, the thread processing circuitry 204 may identify and/or label partitions according to the corresponding performance and/or efficient level. In this manner, the scheduling circuitry 206 can attempt to match the complexity level of the partition with the performance level of the cores. An example of a complex partition may be a partition that includes an advanced vector execution (AVX) instruction set and an example of a non-complex task may be a task that includes an streaming single instruction multiple data (SIMD) extensions (SSE) instruction set.

The example scheduling circuitry 206 of FIG. 2A schedules the partitions for execution on the cores 114, 116 based on the configuration of the cores 114, 116 and/or the complexity of the partitions, while respecting the order of partitions of the same thread. The example scheduling circuitry 206 generate the schedule to ensure efficient use of the core(s) (e.g., so that there is reduced downtime and the complexity of the partitions corresponds to the performance of the cores) to achieve faster instruction execution. For example, the scheduling circuitry 206 may first schedule the highest complex partitions on the highest performance cores, the second highest complex partitions on the second highest performance cores, etc., while respecting the order of the partitions for each thread (e.g., if a thread is broken into three partitions, the first partition should be started and/or complete before the second partition is started). After the initial schedule is generated, the scheduling circuitry 206 can estimate the duration of time to complete all tasks per core type. In this manner, the scheduling circuitry 206 can move partitions around (e.g., while respecting order of the partitions) if one core finishes by more than a threshold amount of time after one or more of the other types of cores. The scheduling circuitry 206 may take a number of iterations of rearranging, depending on the number of levels of cores to develop a schedule that optimize speed and/or efficiency. As described above, the generated schedule is passed to the example OS scheduling circuitry 112 as a suggestion of execution.

FIG. 2B illustrates a block diagram of the example streamed threading circuitry 120 of FIG. 1. The example streamed threading circuitry 120 includes example interface circuitry 210, an example timer 212 (also referred to as timing circuitry), and example cache control circuitry 214.

The example interface circuitry 210 obtains partitions and/or indication that a partition has been obtained by a particular core. In some examples, the interface circuitry 210 obtains location information regarding the location of an output or a partial output of a core when executed a partition (e.g., via an example streamed queue implemented in the example cache 118 of FIG. 1). Additionally, the interface circuitry 210 may store and/or cause a core to store an output or partial output of an execution of a partition to an output buffer implemented in the example cache 118. Additionally, the interface circuitry 210 may store and/or cause a core to store a location/position and/or length of the output and/or partial output of the execution of a partition in the stream queue implemented in the example cache 118 of FIG. 1.

The example timer 212 of FIG. 2 keeps tracks of one or more durations of time. For example, when partition data is obtained by a core (e.g., partial partition information or full partition information), the timer 212 can initiate and flag when one or more threshold amount of time have occurred. In this manner, the example cache control circuitry 214 can output partially complete partition execution so that a core that is implementing a subsequent partition for the same thread can start execution with the partially complete partition execution in a similar manner to streaming.

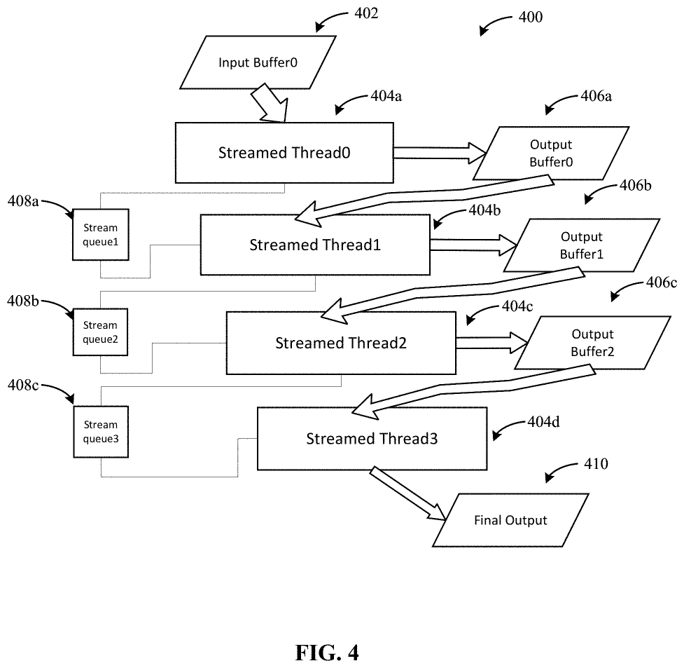

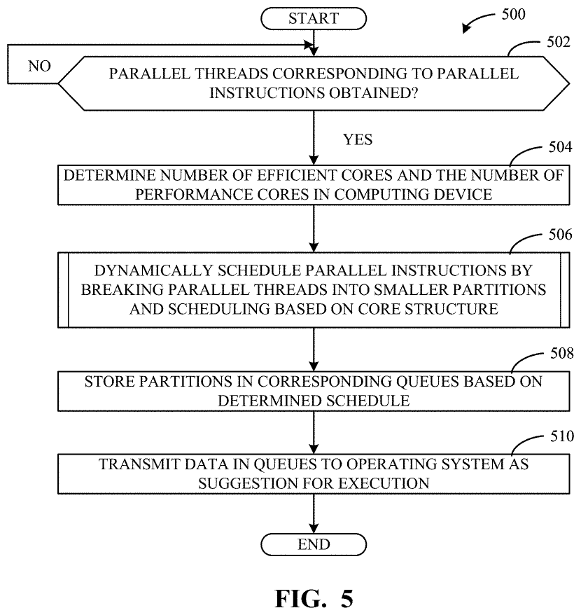

The example cache control circuitry 214 of FIG. 2 controls access to the example cache 118 of FIG. 1 to access portions of the cache to determine when location information for partial outputs corresponding to partitions have been stored in a streamed queue and access the partial output information from an output buffer. Additionally, the example cache control circuitry 214 instructs the cores to store a location of an output for a partition in the corresponding stream queue after a threshold duration of time. As described above, each thread will have dedicated sections of the cache 118 for the stream queues and output buffers. An example execution of streamed threading that can be implemented by the example streamed threading circuitry 120 is further described below in conjunction with FIG. 4.

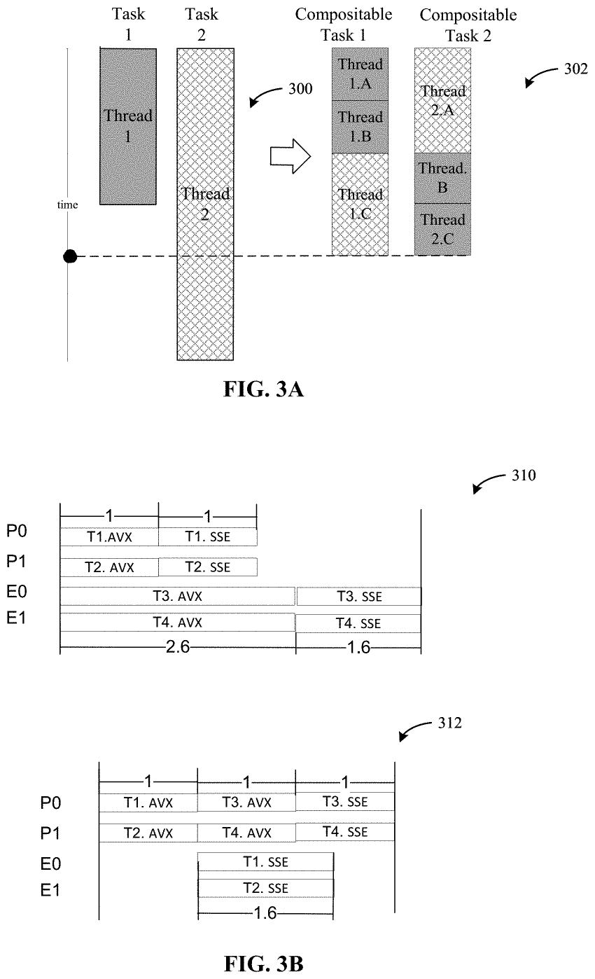

FIG. 3A illustrates an example of the benefit of examples disclosed herein for example parallel instruction with two threads implemented by one P core and one E core. An example timing diagram 300 illustrates the amount of time needed to execute the two threads on the two cores. An example timing diagram 302 illustrates the amount of time needed to execute three partitions of the two threads on the two cores, in conjunction with examples disclosed herein.

The example timing diagram 300 of FIG. 3 illustrates a traditional technique for scheduling parallel threads. In the example timing diagram 300, a first thread is executed by the P core 116 of FIG. 1 and the second thread is executed by the E core 114 of FIG. 1. Because the E core 114 is more efficient, the duration of time needed to complete the second thread is longer than the duration of time to complete the first thread, as shown in the example timing diagram 300. Thus, there is wasted time where the P core 116 is not being utilized while the E core finishes execution, thereby corresponding to inefficiency.

The example timing diagram 302 of FIG. 3 illustrates a technique to schedule parallel threads in conjunction with examples disclosed herein. In the example timing diagram 302, the first thread and the second thread are split into three partitions (e.g., A, B, and C). The first and second partitions (A, B) of the first thread are executed on the P core 116 and the third partition (C) of the first thread are executed on the E core 114, in this manner, the order of the first thread is respected even though the corresponding partitions are executed on different cores. Additionally, the first partition (A) of the second thread is executed on the E core 114 and the second and third partitions (B, C) of the second thread are executed on the P core 116. As shown in the example timing diagrams 300, 302, the duration of time to complete execution of the two threads using examples disclosed herein is less than the duration of time to complete execution of the two threads using traditional techniques.

FIG. 3B illustrates another example of the benefit of examples disclosed herein for parallel instruction with two threads implemented by one P core and one E core. An example timing diagram 300 illustrates the amount of time needed to execute the four threads on the four cores (e.g., two P cores and two E cores). An example timing diagram 302 illustrates the amount of time needed to execute two partitions of the four threads on the four cores, in conjunction with examples disclosed herein.

As shown in the example timing diagram 310 of FIG. 3B, the first performance core (P0) executes a first thread that includes an AVX portion and an SSE portion, the second performance core (P1) executes a second thread that includes an AVX portion and an SSE portion, the first efficient core (E0) executes a third thread that includes an AVX portion and an SSE portion, and the second efficient core (E1) executes a fourth thread that includes an AVX portion and an SSE portion. As described above, AVX instructions are more complex (e.g., require more time and/or resources to execute) than SEE instructions. In the example timing diagram 310, the performance core P0 is able to complete the first thread in 2 time units (e.g., 2 milliseconds (ms)), with 1 time unit for the AVX portion and 1 time unit for the SEE portion. Likewise, the performance core is able to complete the second thread in 2 time units. Due to the structure of the efficient core and the complexify of the AVX and SSE portions, the efficient core E0 is able to complete the third task in 4.6 time units, with 2.6 time units to complete the AVX portion or the thread and 1.6 second to complete the SSE portion of the thread. Likewise, the efficient core E1 is able to complete the forth task in 4.6 time units. Accordingly, to complete the four threads, the traditional technique corresponding to the example timing diagram 310 takes 4.6 time units to complete with 2.6 seconds of idle time for the P0 core and 2.6 seconds of idle time for the P1 core.

The example timing diagram 312 of FIG. 3B illustrates a splitting of the four threads into two partitions (e.g., an AVX partition, and a SSE partition). The example instruction processing circuitry 104 may break the task according to the AVX, SSE parts and determine that the AVX task is more complex than the SSE task. In this manner, the instruction processing circuitry 104 can attempt to schedule the most or all of the AVX tasks on the performance cores and schedule SSE tasks on either performance cores or efficient cores (e.g., depending on the order of the partitions and to improve efficiency and/or time). As shown in the example timing diagram 312, the example instruction processing circuitry 104 schedules the AVX partition of the first thread on the performance core P0, the AVX partition of the second thread on the performance core P1, the AVX partition of the third thread on the performance core P0 after execution of the first AVX portion of the first thread, and the AVX partition of the fourth thread on the performance core P1 after execution of the second AVX portion of the second thread. In this manner, all AVX partitions (e.g., corresponding to more complex partitions) are scheduled on the performance cores. However, in some examples, one or more of the performance cores may be scheduled on efficient cores depending on the number of performance and efficient cores and the number of higher complexity partitions vs lower complexity partitions. The example instruction processing circuitry 104 schedules the SSE partition of the first thread on the efficient after and/or near completion of the AVX partition of the first thread (e.g., to preserve the order of the partitions of the thread). In some examples, the instruction processing circuitry 104 may schedule the SSE tasks for the first and second threads during the execution of the AVX tasks of the first and second threads by implementing the streaming thread technique described throughout. The example instruction processing circuitry 104 may schedule the remaining SSE tasks for the third and fourth partitions on either the performance cores (e.g., because the AVX tasks are all complete) or the efficient task. However, because execution on the performance cores will complete faster (e.g., 0.6 time unites faster in this example) than the efficient cores, the instruction processing circuitry 104 schedules the SSE tasks for the third and fourth partitions on the performance cores. In this manner, the four threads are complete in 3 time units with only 1.4 time units of idle time for each efficient core. Accordingly, in the example of FIG. 3B, examples disclosed herein result in 1.2 time units reduction of time (e.g., 40% reduction) to complete with 2.4 time units reduction (e.g., 85.7%) of idle time.

FIG. 4 illustrates an example stream threading protocol 400 that can be implemented by the example streamed threading circuitry of FIG. 1 and/or 2B. The example protocol 400 includes an example input buffer 402, example streamed threads 404a-d, example output buffers 406a-c, example stream queues 408a-c, and example final output buffer 410. Although the example of FIG. 4 includes four streamed threads corresponding to four partitions, FIG. 4 may be described in conjunction with any number of threads for any number of partitions. In the example of FIG. 4 each partition is executed by a different E core. However, the partitions may be executed by any number and/or type of cores.

Each of the input buffer 402, output buffers 406a-c, stream queues 408a-c, and final output buffer of FIG. 4 is implemented in the example cache 118 of FIG. 1. The streamed threading disclosed herein support pipelined partition execution. Each thread and/or partitions of a thread correspond to the dedicated spaces of the cache 118. The streamed partitions are chained by the stream queues 408a-c as producer and consumer pairs. One streamed thread will push entries (e.g., including position/location information and length of data information) to the corresponding stream queue 408a-c, the core scheduled to implement the proceeding partition will pop entries in first in first out order to get the next input stream address and range. In this manner, the streamed threading protocol results in faster execution so that the efficient cores act similar to a performance core.

During execution of a workload, different cores may implement the different partitions of a thread. As described above, the partitions need to be executed in order. However, the example streamed threading circuitry 120 can facilitate a stream protocol so that different core(s) can execute subsequent partitions for the same thread before the prior partition is complete. For example, a first core of the cores 114, 116 may access the first partition 404a of a thread from the input buffer 402 for execution. After a threshold amount of time, the first core stores a partial output of the execution of the first thread 404a to the output buffer 406a and stores information about the output (e.g., location information of the output buffer 206a and length of output) in the stream queue 408a. In this manner, the streamed threading circuitry 120 can monitor when the stream queue 408a has been updated and instruct the second core to access the partial output of the first core corresponding to the first partition to start execution of the second partition before the execution of the first partition is complete. The processor continues for the subsequent partitions until the last core stores the final output in the example final output buffer 410. Using the example streamed threading protocol, execution of a thread can be thread up by more than three times faster than using traditional techniques.

While an example manner of implementing the computing device 100 of FIG. 1 is illustrated in FIG. 1 and/or 2, one or more of the elements, processes, and/or devices illustrated in FIGS. 1 and/or 2 may be combined, divided, re-arranged, omitted, eliminated, and/or implemented in any other way. Further, the example queues 106, 108, the example web working circuitries 110a, 110b, the example OS scheduling circuitry 112, the example cores 114, 116, the example cache 118, and/or, more generally, the example instruction processing circuitry 104, the streamed threading circuitry 120, the example computing device 100 of FIGS. 1 and/or 2, may be implemented by hardware alone or by hardware in combination with software and/or firmware. Thus, for example, any of the example queues 106, 108, the example web working circuitries 110a, 110b, the example OS scheduling circuitry 112, the example cores 114, 116, the example cache 118, and/or, more generally, the example instruction processing circuitry 104, the streamed threading circuitry 120, the example computing device 100 of FIGS. 1 and/or 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example computing device 100 of FIGS. 1 and/or 2 may include one or more elements, processes, and/or devices in addition to, or instead of, those illustrated in FIGS. 1 and/or 2, and/or may include more than one of any or all of the illustrated elements, processes and devices.

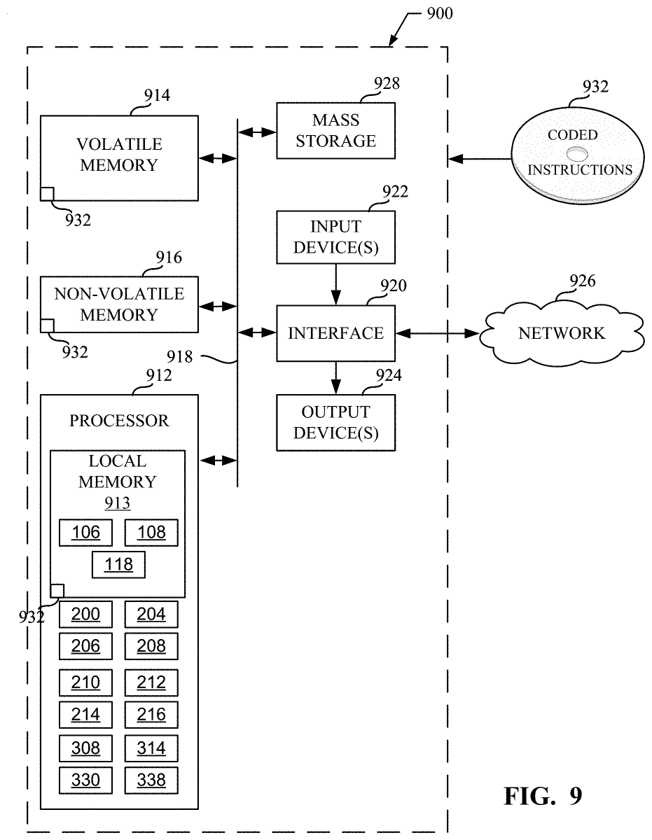

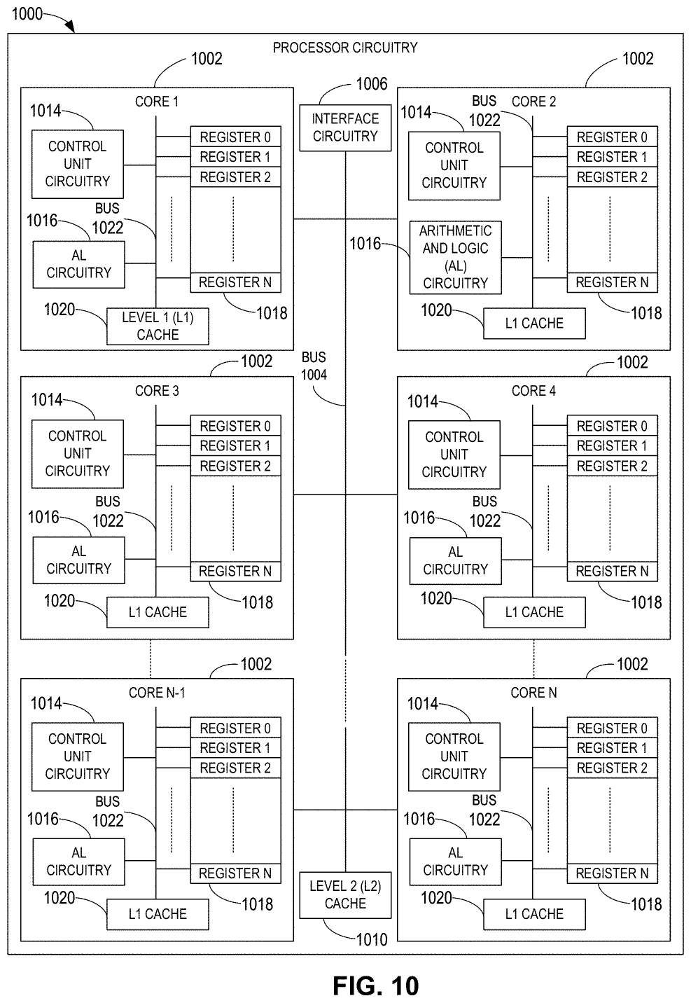

Flowcharts representative of example machine readable instructions, which may be executed to configure processor circuitry to implement the example computing device 100 of FIGS. 1 and/or 2, is shown in FIGS. 5-8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 5-8, many other methods of implementing the example computing device 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to implement the computing device 100 to split parallel instructions into threads and generate an execution schedule of the threads. Although the flowcharts are described in conjunction with a two level system (e.g., performance cores and efficient cores), the flowcharts may be described in conjunction with any number, type, and/or levels of cores. The machine readable instructions and/or the operations 500 of FIG. 5 begin at block 502, at which the example interface circuitry 200 determines if threads corresponding to parallel instructions (e.g., one or more tasks and/or instructions that includes threads that can be executed in parallel) have been obtained via the example network 122 of FIG. 1.

If the example interface circuitry 200 determines that parallel threads have not been obtained (block 502: NO), control returns to block 502 until parallel threads are obtained. If the example interface circuitry 200 determines that parallel threads have been obtained (block 502: YES), the example configuration determination circuitry 202 determines the number and/or type of efficient cores and/or the number and/or type of performance cores implemented on the example computing device 100. As described above, the example instruction processing circuitry 104 attempts to match complexity of partitions with performance of the cores to increase efficiency. Accordingly, the configuration determination circuitry 202 determines the number and/or type of cores 114, 116 implemented on the computing device 100 to be able to schedule efficiently.

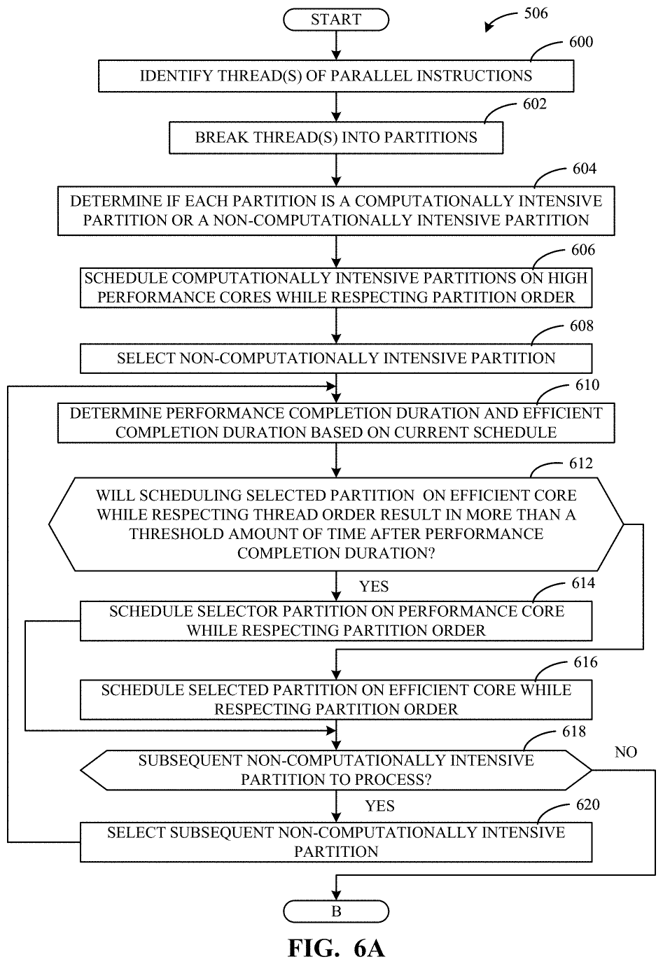

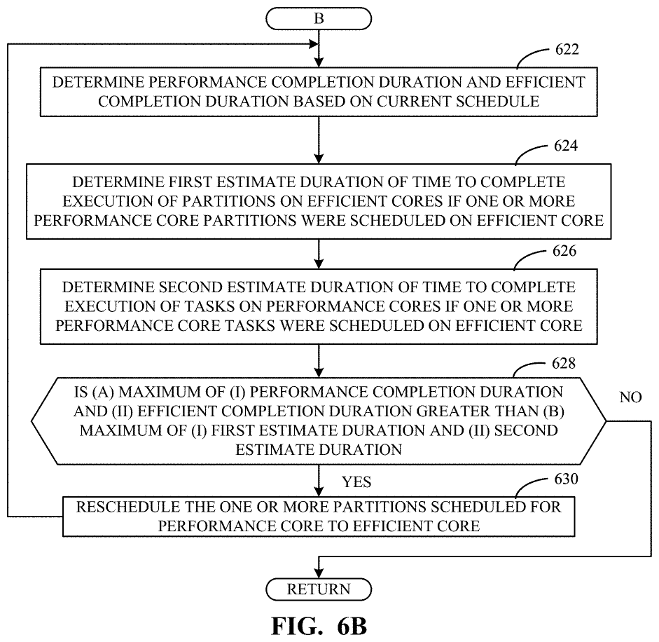

At block 506, the example instruction processing circuitry 104 dynamically schedules parallel instructions by breaking the parallel threads into smaller partitions and scheduling the partitions based on the hybrid core structure, as further described below in conjunction with FIGS. 6A and 6B. At block 508, the example interface circuitry 200 stores partitions in the example queues 106, 108 based on the determined schedule. For example, the interface circuitry 200 stores partitions in the advance queue 106 as a suggestion to be executed by the performance cores. Additionally, the interface circuitry 200 stores partitions in the common queue 108 as a suggestion to be executed by the efficient cores. At block 510, the example interface circuitry 200 and/or the web working circuitry 110a, 110b transmit the data in the queues 106, 108 (e.g., corresponding to the generated schedule) to the OS scheduling circuitry 112 as a suggestion for execution.

FIG. 6 is a flowchart representative of example machine readable instructions and/or example operations 506 that may be executed and/or instantiated by processor circuitry to implement the computing device 100 to dynamically schedule parallel instructions by breaking parallel threads into smaller partitions and scheduling the partitions based on the core structure and/or the complexity of the partitions, as described above in conjunction with block 506 of FIG. 5. The machine readable instructions and/or example operations 506 are described in conjunction with a computing device that has one or more performance core(s) of a single type and one or more efficient core(s) of a single type. However, the machine readable instructions and/or example operations 506 may be adjusted to be described in conjunction with more than one type of performance core and/or more than one type of commercial core.

The machine readable instructions and/or the operations 506 of FIG. 6 begin at block 600, at which the example thread processing circuitry 204 identifies thread(s) of the parallel instructions. At block 602, the example thread processing circuitry 204 breaks the thread(s) into partitions. The thread processing circuitry 204 may break the thread(s) into partitions based on the threads themselves and/or based on the configuration of the cores. For example, if the thread has complex portions and less complex portions, the thread processing circuitry 204 can break the thread into the complex portions and the less complex portions. Additionally or alternatively, the thread processing circuitry 204 may break a thread into a number of partitions based on the number of cores.

At block 604, the example thread processing circuitry 204 determines if each partition is a computationally intensive partition (e.g., more than a threshold amount of complexity) or a non-computationally intensive partition (e.g., less than a threshold amount of complexity). The complexity may be based on the size and/or number of lines of code, the type of operations in the lines of code, the type of data processed within the lines of code, the number of instructions in the lines of code, the data accessed, affinity level, urgency of the code or the data in the code, time sensitiveness of the code or the tasks in the code, whether the code is lightweight, etc. At block 606, the example scheduling circuitry 206 schedules the computationally intensive partitions on the performance cores while respecting partition order of the partitions corresponding to a same thread. For example is there are two computationally intensive partitions for the same thread, the scheduling circuitry 206 will ensure that the first partition is scheduled before the second partition.

At block 608, the scheduling circuitry 206 selects a non-computationally intensive partition. At block 610, the example scheduling circuitry 206 determines a performance completion duration (e.g., a total duration to execute all scheduled partitions on the P cores 116) and an efficient completion duration (e.g., a total duration to execute all scheduled partitions on the E cores 114) based on the current schedule. For example, the scheduling circuitry 206 determines how long each scheduled partition will take to execute for each core and sums the durations per core. If there is any gap in scheduling, the example scheduling circuitry 206 can add the gap duration to the performance complete duration and/or efficient completion duration. If the duration of execution of the P cores are different, the scheduling circuitry 206 may determine the performance completion duration based on the shortest duration of execution of the P cores. Additionally, if the duration of execution of the E cores are different, the scheduling circuitry 206 may determine the efficient completion duration based on the shortest duration of execution of the E cores.

At block 612, the example scheduling circuitry 206 determines if scheduling the selected partition on an efficient core while respecting thread order will result in the efficient completion duration being more than a threshold amount of time (e.g., a duration corresponding to an estimate for how long the selected partition would take to complete using the P core 116) after the performance completion duration. For example, if the performance completion duration is 15 ms, the efficient completion duration is 14 ms, the duration of time to complete the selected task is 1.5 ms on an E core and 1 ms on a P core (e.g., thus 1 ms is the threshold), then the example scheduling circuitry 206 will determine that scheduling the selected task on the E core will change the efficient completion duration from 14 ms to 15.5 ms. Additionally, the scheduling circuitry 206 determines that 15.5 is less than the threshold amount of time after the performance completion duration (e.g., 15.5 ms<15 ms+1 ms).

If the example scheduling circuitry 206 determines that scheduling the selected partition on the E core 114 while respecting thread order will result in more than a threshold amount of time after the performance completion duration (block 612: YES), the scheduling circuitry 206 schedules the selected partition on a P core of the P cores 116 while respecting partition order (e.g., to ensure that a subsequent partition of the same thread is started and/or complete before starting the selected partition) (block 614). In this manner, although P cores are generally reserved for computationally intensive tasks, if all the computationally partitions are complete, the scheduling circuitry 206 can increase efficiency and time by scheduling additional non-computationally intensive partitions on P cores that would otherwise remain idle. If the example scheduling circuitry 206 determines that scheduling the selected partition on the E core 114 while respecting thread order will not result in more than a threshold amount of time after the performance completion duration (block 612: NO), the scheduling circuitry 206 schedules the selected partition on a E core of the E cores 114 while respecting partition order (e.g., to ensure that a subsequent partition of the same thread is started and/or complete before starting the selected partition) (block 616).

At block 618, the example scheduling circuitry 206 determines if there is a subsequent non-computationally intensive partition to process. If the scheduling circuitry 206 determines that there is a subsequent non-computationally intensive partition to process (block 618: YES) the example scheduling circuitry 206 selects the subsequent non-computationally intensive partition (block 620) and control returns to block 610 to schedule the subsequent partition. If the scheduling circuitry 206 determines that there is not a subsequent non-computationally intensive partition to process (block 618: NO), the scheduling circuitry 206 determines the performance completion duration and the efficient completion duration based on the current schedule (block 622 of FIG. 6B). For example, based on the current schedule, the scheduling circuitry 206 determines the total amount of time needed to complete all partitions on the P cores and the total amount of time needed to complete all partitions on the E cores. If the duration of execution of the P cores are different, the scheduling circuitry 206 may determine the performance completion duration based on the shortest duration of execution of the P cores. Additionally, if the duration of execution of the E cores are different, the scheduling circuitry 206 may determine the efficient completion duration based on the shortest duration of execution of the E cores.

The instructions and/or operations of FIG. 6B may be used to increase efficiency and/or speed of execution when (a) there are more computationally intensive partitions than non-computationally intensive partitions and/or (b) there are limited P cores and/or substantial E cores in the computing device 100. For example, if there are 10 computationally intensive partitions for a small number of P cores and only 2 non-computationally intensive partitions for a large number of E cores, the E cores will have a lot of idle time while the P cores execute the computationally intensive partitions. Accordingly, the scheduling circuitry 206 may analyze the schedule to reduce E core idle time and decrease the total duration of execution by utilizing the idle E cores.

At block 624, the example scheduling circuitry 206 determines a first estimate duration to complete execution of partitions on the E cores 114 if one or more partitions currently scheduled on a P core were scheduled on an E core(s). At block 626, the example scheduling circuitry 206 determines a second estimate duration to complete execution of the partitions on the P cores 116 if the one or more partitions currently scheduling on a P core were scheduled on the E core(s). At block 628, the example scheduling circuitry 206 determines if (a) the maximum of (i) the performance completion duration and (ii) the efficient duration is greater than (b) the maximum of (i) the first estimate duration and (ii) the second estimate duration. If (a) the maximum of (i) the performance completion duration and (ii) the efficient duration is greater than (b) the maximum of (i) the first estimate duration and (ii) the second estimate duration, then the scheduling circuitry 206 determines efficiency and/or speed of execution of the all the threads may be increased by moving that one or more of the computationally intensive portions to one or more of the E cores 114.

If the example scheduling circuitry 206 determines that (a) the maximum of (i) the performance completion duration and (ii) the efficient duration is greater than (b) the maximum of (i) the first estimate duration and (ii) the second estimate duration (block 628: YES), the example scheduling circuitry 206 reschedules the one or more partitions allocated and/or assigned to the P core(s) 116 to one or more of the E core(s) 114 (block 630), and control returns to block 622 to see if it is more efficient to more additional performance core partitions to the E core(s) 114. If the example scheduling circuitry 206 determines that (a) the maximum of (i) the performance completion duration and (ii) the efficient duration is not greater than (b) the maximum of (i) the first estimate duration and (ii) the second estimate duration (block 628: NO), control returns to block 508 of FIG. 5.

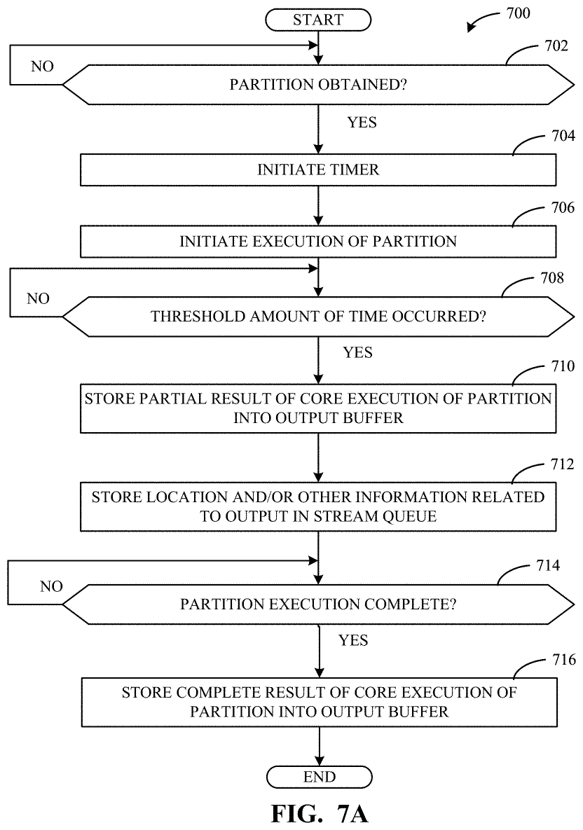

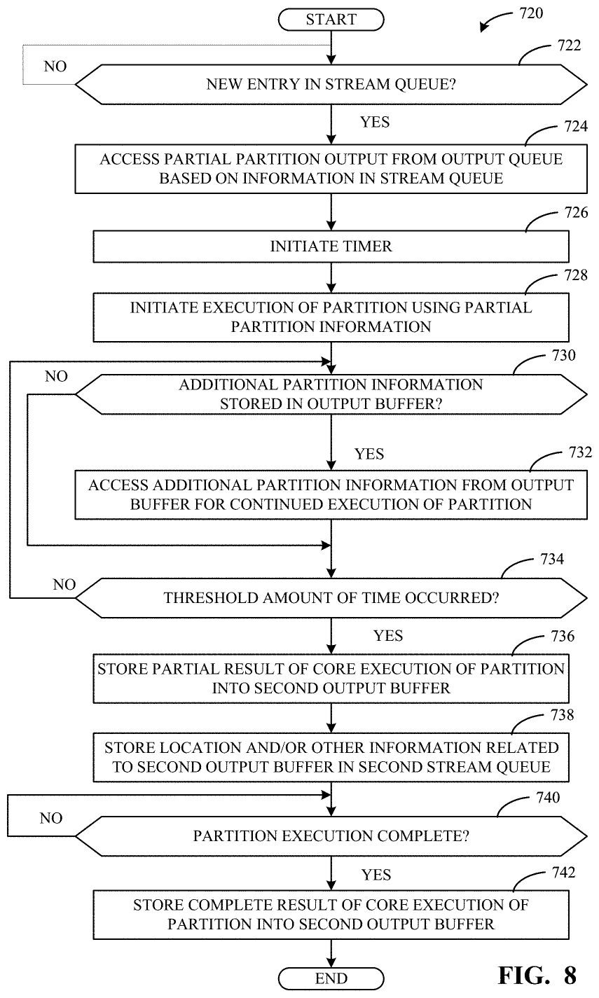

FIG. 7 is a flowchart representative of example machine readable instructions and/or example operations 700 that may be executed and/or instantiated by processor circuitry to implement the streamed threading circuitry 120 to split parallel instructions into threads and generate an execution schedule of the threads. The instructions and/or operations of FIG. 7 correspond to execution of a first (e.g., initial) partition of a thread. Execution of subsequent partitions of a thread are described in conjunction with FIG. 8. The machine readable instructions and/or the operations 700 of FIG. 7 begin at block 702, at which the interface circuitry 210 determines if a partition is obtained. If the interface circuitry 210 determines that a partition has not been obtained (block 702: NO), control returns to block 702 until a partition is obtained.

If the example interface circuitry 210 determines that a partition has been obtained (block 702: YES), the example timer 212 initiates (block 704) to start tracking time. At block 706, the example interface circuitry 210 initiates execution of the partition by instructing the corresponding core to initiate execution of the partition.

At block 708, the example cache control circuitry 214 determines if a threshold amount of time has occurred by monitoring the example timer 212. The threshold may be based on user and/or manufacturer preferences. If the example cache control circuitry 214 determines that the threshold amount of time has not occurred (block 708: NO), control returns to block 708 until the threshold amount of time has occurred. If the example cache controller circuitry 214 determines that the threshold amount of time has occurred (block 708: YES), the example cache control circuitry 214 instructs the core to output and/or store a partial result of the core execution for the partition into an output buffer (e.g., the example output buffer 406a of FIG. 4, which is implemented in a portion of the example cache 118 of FIG. 1) (block 710). At block 712, the example cache control circuitry 214 stores the location and/or other information related to the output and/or partial output to a stream queue (e.g., the example stream queue 408a, implemented in the example cache 118 of FIG. 2).

At block 714, the example cache control circuitry 214 determines if partition execution is complete. If the example cache control circuitry 214 determines that the partition execution is not complete (block 714: NO), control returns to block 714 until the partition execution is complete. In some examples, if the cache control circuitry 214 determines that the partition execution is not complete, control may return to block 708 to store subsequent partial result of core execution for the partition after a second threshold amount of time. If the example cache control circuitry 214 determines that the partition execution is complete (block 714: YES), the example cache control circuitry 214 cases the core to store complete result of the core execution for the partition into the output buffer (e.g., the output buffer 406a of FIG. 4) (block 716) and the instructions end.

FIG. 8 is a flowchart representative of example machine readable instructions and/or example operations 820 that may be executed and/or instantiated by processor circuitry to implement the streamed threading circuitry 120 to split parallel instructions into threads and generate an execution schedule of the threads. The instructions and/or operations of FIG. 8 correspond to execution of a partition after the initial partition of a thread. The machine readable instructions and/or the operations 800 of FIG. 8 begin at block 802, at which the interface circuitry 210 determines there is a new entry in a stream queue corresponding to the partition (e.g., the stream queue 408a of FIG. 4 when processing a second partition of a thread). As described above, when an antecedent partition of a thread is partially complete, the streamed threading circuitry 120 causes data related to the antecedent partition to be stored in the stream queue. In this manner, the streamed threading circuitry 120 can facilitate execution of the partition prior to full execution of the antecedent partition.

If the interface circuitry 210 determines that there is not a new entry in a stream queue corresponding to the partition (block 822: NO), control returns to block 822 until a partition is obtained. If the interface circuitry 210 determines that there is a new entry in a stream queue corresponding to the partition (block 822: YES), the example cache control circuitry 214 causes the core to access partial partition output from the first output queue based on information (e.g., identifying a location of the partial output in the cache 118) from the first stream queue (block 824). At block 826, the example timer 212 initiates to start tracking time. At block 828, the example interface circuitry 210 initiates execution of the partition using the accessed partial partition by instructing the corresponding core to initiate execution of the partition.

At block 830, the cache control circuitry 214 determines if additional partition information has been stored in output buffer (e.g., the output buffer 406a of FIG. 4). For example, the core that is executing the antecedent partition may output the full partition execution output or an additional partial partition output to the output buffer. If the example cache control circuitry 214 determines that additional partition information has not been stored in the output buffer (block 830: NO), control continues to block 836. If the example cache control circuitry 214 determines that additional partition information has been stored in the output buffer (block 830: YES), the example cache control circuitry 214 access and/or causes the core to access the additional partition information from the output buffer for continued execution of the partition (block 832).

At block 834, the example cache control circuitry 214 determines if a threshold amount of time has occurred by monitoring the example timer 212. The threshold may be based on user and/or manufacturer preferences. If the example cache control circuitry 214 determines that the threshold amount of time has not occurred (block 834: NO), control returns to block 830 until the threshold amount of time has occurred and/or until additional partition information is stored in the output buffer. If the example cache controller circuitry 214 determines that the threshold amount of time has occurred (block 834: YES), the example cache control circuitry 214 instructs the core to output and/or store a partial result of the core execution for the partition into an output buffer (e.g., the example output buffer 406b of FIG. 4, which is implemented in a portion of the example cache 118 of FIG. 1) (block 836). At block 838, the example cache control circuitry 214 stores the location and/or other information related to the output and/or partial output to a stream queue (e.g., the example stream queue 408b, implemented in the example cache 118 of FIG. 2).

At block 840, the example cache control circuitry 214 determines if partition execution is complete. If the example cache control circuitry 214 determines that the partition execution is not complete (block 840: NO), control returns to block 840 until the partition execution is complete. In some examples, if the cache control circuitry 214 determines that the partition execution is not complete, control may return to block 808 to store subsequent partial result of core execution for the partition after a second threshold amount of time. If the example cache control circuitry 214 determines that the partition execution is complete (block 840: YES), the example cache control circuitry 214 cases the core to store complete result of the core execution for the partition into the output buffer (e.g., the output buffer 406b of FIG. 4) (block 842) and the instructions end.

FIG. 9 is a block diagram of an example processor platform 900 structured to execute and/or instantiate the machine readable instructions and/or the operations of FIGS. 5-8 to implement the computing device 100 of FIG. 1. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the example web working circuitries 110a, 110b, the example OS scheduling circuitry 112, the example interface circuitry 200, the example configuration determination circuitry 202, the example thread processing circuitry 204, the example scheduling circuitry 206, the example interface circuitry 210, the example timer 212, and the example cache control circuitry 214 of FIGS. 1, 2A, and/or 2B.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 932, which may be implemented by the machine readable instructions of FIGS. 5-8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowchart of FIGS. 5-8 to effectively instantiate the computing device 100 of FIG. 2 as logic circuits to perform the operations corresponding to those machine readable instructions. In some such examples, the computing device 100 of FIG. 2 is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIG. 5-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

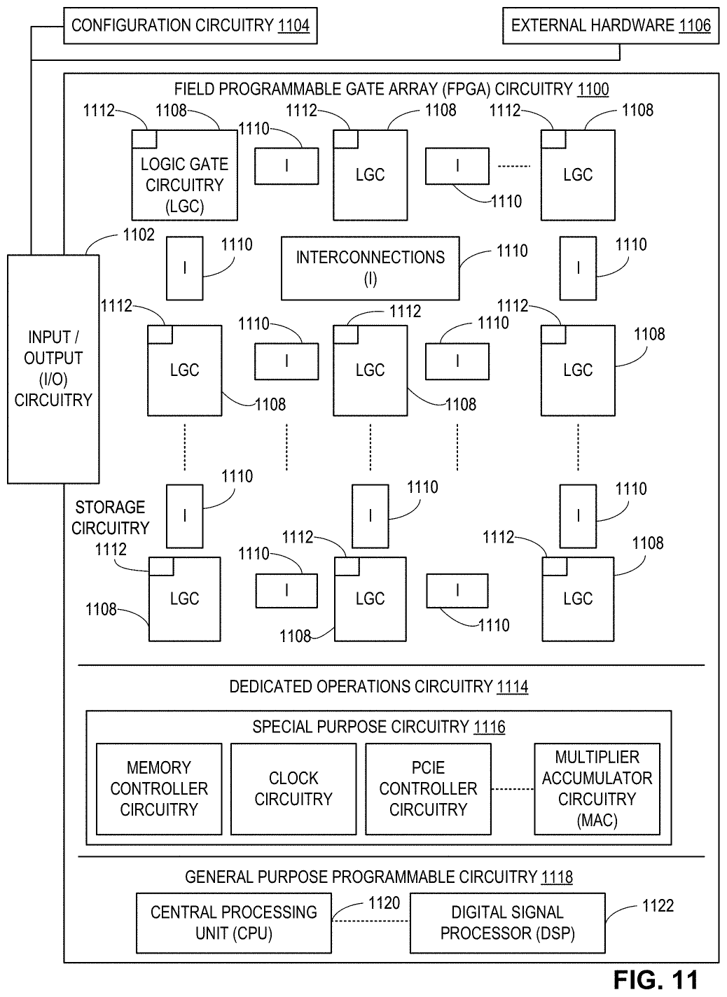

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 5-8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 5-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 5-8. As such, the FPGA circuitry 1100 may be structured to effectively instantiate some or all of the machine readable instructions of the flowcharts of FIGS. 5-8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 5-8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions of FIGS. 5-8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 5-8 may be executed by one or more of the cores 1002 of FIG. 10, a second portion of the machine readable instructions represented by the flowcharts of FIGS. 5-8 may be executed by the FPGA circuitry 1100 of FIG. 11, and/or a third portion of the machine readable instructions represented by the flowcharts of FIGS. 5-8 may be executed by an ASIC. It should be understood that some or all of the computing device 110 of FIG. 2 may, thus, be instantiated at the same or different times. Some or all of the circuitry may be instantiated, for example, in one or more threads executing concurrently and/or in series. Moreover, in some examples, some or all of the computing device 110 of FIG. 2 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

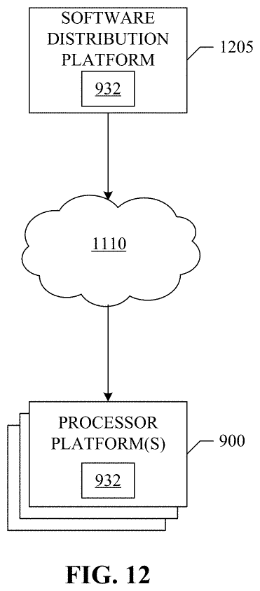

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 500, 506, 700, 720, 932 of FIG. 5-8. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions 500, 506, 700, 720, 932 of FIG. 5-8, as described above. The one or more servers of the example software distribution platform 1205 are in communication with an example network 1210, which may correspond to any one or more of the Internet and/or any of the example network 122 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 500, 506, 700, 720, 932 of FIG. 5-8 from the software distribution platform 1205. For example, the software, which may correspond to the example machine readable instructions 500, 506, 700, 720, 932 of FIG. 5-8, may be downloaded to the example processor platform 900, which is to execute the machine readable instructions 932 to implement the computing device 100. In some examples, one or more servers of the software distribution platform 1005 periodically offer, transmit, and/or force updates to the software (e.g., the example machine readable instructions 500, 506, 700, 720, 932 of FIG. 5-8) to ensure improvements, patches, updates, etc., are distributed and applied to the software at the end user devices.

Example methods, apparatus, systems, and articles of manufacture to schedule parallel instructions using hybrid cores are disclosed herein. Further examples and combinations thereof include the following: Example 1 includes an apparatus to schedule parallel instructions using hybrid cores, the apparatus comprising interface circuitry to obtain instructions, the instructions including parallel threads, and processor circuitry including one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations, the processor circuitry to perform at least one of the first operations, the second operations, or the third operations to instantiate thread processing circuitry to split a first thread of the parallel threads into partitions, scheduling circuitry to select (a) a first core to execute a first partition of the partitions and (b) a second core different than the first core to execute a second partition of the partitions, and generate an execution schedule based on the selection, the interface circuitry to transmit the execution schedule to a device that schedules instructions on the first and second core.

Example 2 includes the apparatus of example 1, wherein the thread processing circuitry is to determine a first complexity of the first partition and a second complexity of the second partition.

Example 3 includes the apparatus of example 2, wherein the scheduling circuitry is to select the first core based on the first complexity and the second core based on the second complexity.

Example 4 includes the apparatus of example 1, wherein the first core is a performance core and the second core is an efficient core.

Example 5 includes the apparatus of example 1, wherein the device causes the first core to execute the first partition and causes the second core to execute the second partition.

Example 6 includes the apparatus of example 1, wherein the scheduling circuitry is to schedule the second partition to be executed by the second core after the first core begins execution of the first partition.

Example 7 includes the apparatus of example 1, wherein the thread processing circuitry is to split the first thread of the parallel threads into the partitions based on a complexity of portions of the first thread.

Example 8 includes an apparatus to schedule parallel instructions using hybrid cores, the apparatus comprising at least one memory, machine readable instructions, and processor circuitry to at least one of instantiate or execute the machine readable instructions to split a first thread of parallel threads of instructions into partitions, select (a) a first core to execute a first partition of the partitions and (b) a second core different than the first core to execute a second partition of the partitions, generate an execution schedule based on the selection, and transmit the execution schedule to a device that schedules instructions on the first and second core.

Example 9 includes the apparatus of example 8, wherein the processor circuitry is to determine a first complexity of the first partition and a second complexity of the second partition.

Example 10 includes the apparatus of example 9, wherein the processor circuitry is to select the first core based on the first complexity and the second core based on the second complexity.

Example 11 includes the apparatus of example 8, wherein the first core is a performance core and the second core is an efficient core.

Example 12 includes the apparatus of example 8, wherein the device causes the first core to execute the first partition and causes the second core to execute the second partition.

Example 13 includes the apparatus of example 8, wherein the processor circuitry is to schedule the second partition to be executed by the second core after the first core begins execution of the first partition.

Example 14 includes the apparatus of example 8, wherein the processor circuitry is to split the first thread of the parallel threads into the partitions based on a complexity of portions of the first thread.

Example 15 includes a non-transitory machine readable storage medium comprising instructions that, when executed, cause processor circuitry to at least generate partitions from a first thread of parallel threads, identify (a) a first core to execute a first partition of the partitions and (b) a second core different than the first core to execute a second partition of the partitions, and generate a schedule based on the identification, and cause transmission of the schedule to a scheduler that schedules instructions on the first and second core.

Example 16 includes the non-transitory machine readable storage medium of example 15, wherein the instructions cause the processor circuitry to determine a first complexity of the first partition and a second complexity of the second partition.

Example 17 includes the non-transitory machine readable storage medium of example 16, wherein the instructions cause the processor circuitry to identify the first core based on the first complexity and the second core based on the second complexity.

Example 18 includes the non-transitory machine readable storage medium of example 15, wherein the first core is a performance core and the second core is an efficient core.

Example 19 includes the non-transitory machine readable storage medium of example 15, wherein the scheduler causes the first core to execute the first partition and causes the second core to execute the second partition.

Example 20 includes the non-transitory machine readable storage medium of example 15, wherein the instructions cause the processor circuitry to schedule the second partition to be executed by the second core after the first core begins execution of the first partition.

Example 21 includes the non-transitory machine readable storage medium of example 15, wherein the instructions cause the processor circuitry to split the first thread of the parallel threads into the partitions based on a complexity of portions of the first thread.

Example 22 includes an apparatus comprising means for splitting a first thread of parallel threads into partitions, means for generating an execution schedule to select (a) a first core to execute a first partition of the partitions and (b) a second core different than the first core to execute a second partition of the partitions, generate the execution schedule based on the selection, and means for transmitting the execution schedule to a device that schedules instructions on the first and second core.

Example 23 includes the apparatus of example 22, wherein the means for splitting is to determine a first complexity of the first partition and a second complexity of the second partition.

Example 24 includes the apparatus of example 23, wherein the means for generating is to select the first core based on the first complexity and the second core based on the second complexity.

Example 25 includes the apparatus of example 22, wherein the first core is a performance core and the second core is an efficient core.

From the foregoing, it will be appreciated that example systems, methods, apparatus, and articles of manufacture have been disclosed that schedule parallel instructions using hybrid cores. Examples disclosed herein increase the efficiency and/or speed of parallel instruction execution by dynamically breaking, decomposing, grouping, and/or sectioning parallel threads into smaller partitions (also referred to as portion, sub threads, subtasks, etc.) and scheduling the partitions across the cores of the computing device according to the configuration of the computing device. By breaking up a thread into two or more partitions, the partitions can be scheduled across the cores according to the complexity of the partitions and the configurations of the cores to reduce the amount of time needed to complete the threads and increase the efficiency of the execution by ensuring that cores are not idle while other cores are working. Additionally, examples disclosed herein utilize streamed threads to support thread pipelining with dreaming data form the operating system (OS) level for increased speed and efficiency. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to schedule parallel instructions using hybrid cores, the apparatus comprising:
interface circuitry to obtain instructions, the instructions including parallel threads; and
processor circuitry including one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations, or the third operations to instantiate:
thread processing circuitry to split a first thread of the parallel threads into partitions;
scheduling circuitry to:
select (a) a first core to execute a first partition of the partitions and (b) a second core different than the first core to execute a second partition of the partitions; and
generate an execution schedule based on the selection, the interface circuitry to transmit the execution schedule to a device that schedules instructions on the first and second core.

2. The apparatus of claim 1, wherein the thread processing circuitry is to determine a first complexity of the first partition and a second complexity of the second partition.

3. The apparatus of claim 2, wherein the scheduling circuitry is to select the first core based on the first complexity and the second core based on the second complexity.

4. The apparatus of claim 1, wherein the first core is a performance core and the second core is an efficient core.

5. The apparatus of claim 1, wherein the device causes the first core to execute the first partition and causes the second core to execute the second partition.

6. The apparatus of claim 1, wherein the scheduling circuitry is to schedule the second partition to be executed by the second core after the first core begins execution of the first partition.

7. The apparatus of claim 1, wherein the thread processing circuitry is to split the first thread of the parallel threads into the partitions based on a complexity of portions of the first thread.

8. An apparatus to schedule parallel instructions using hybrid cores, the apparatus comprising:
at least one memory;
machine readable instructions; and
processor circuitry to at least one of instantiate or execute the machine readable instructions to:
split a first thread of parallel threads of instructions into partitions;
select (a) a first core to execute a first partition of the partitions and (b) a second core different than the first core to execute a second partition of the partitions;
generate an execution schedule based on the selection; and
transmit the execution schedule to a device that schedules instructions on the first and second core.

9. The apparatus of claim 8, wherein the processor circuitry is to determine a first complexity of the first partition and a second complexity of the second partition.

10. The apparatus of claim 9, wherein the processor circuitry is to select the first core based on the first complexity and the second core based on the second complexity.

11. The apparatus of claim 8, wherein the first core is a performance core and the second core is an efficient core.

12. The apparatus of claim 8, wherein the device causes the first core to execute the first partition and causes the second core to execute the second partition.

13. The apparatus of claim 8, wherein the processor circuitry is to schedule the second partition to be executed by the second core after the first core begins execution of the first partition.

14. The apparatus of claim 8, wherein the processor circuitry is to split the first thread of the parallel threads into the partitions based on a complexity of portions of the first thread.

15. A non-transitory machine readable storage medium comprising instructions that, when executed, cause processor circuitry to at least:
generate partitions from a first thread of parallel threads;
identify (a) a first core to execute a first partition of the partitions and (b) a second core different than the first core to execute a second partition of the partitions; and
generate a schedule based on the identification; and
cause transmission of the schedule to a scheduler that schedules instructions on the first and second core.

16. The non-transitory machine readable storage medium of claim 15, wherein the instructions cause the processor circuitry to determine a first complexity of the first partition and a second complexity of the second partition.

17. The non-transitory machine readable storage medium of claim 16, wherein the instructions cause the processor circuitry to identify the first core based on the first complexity and the second core based on the second complexity.

18. The non-transitory machine readable storage medium of claim 15, wherein the first core is a performance core and the second core is an efficient core.

19. The non-transitory machine readable storage medium of claim 15, wherein the scheduler causes the first core to execute the first partition and causes the second core to execute the second partition.

20. The non-transitory machine readable storage medium of claim 15, wherein the instructions cause the processor circuitry to schedule the second partition to be executed by the second core after the first core begins execution of the first partition.

21. The non-transitory machine readable storage medium of claim 15, wherein the instructions cause the processor circuitry to split the first thread of the parallel threads into the partitions based on a complexity of portions of the first thread.

22. An apparatus comprising:
means for splitting a first thread of parallel threads into partitions;
means for generating an execution schedule to:
select (a) a first core to execute a first partition of the partitions and (b) a second core different than the first core to execute a second partition of the partitions;
generate the execution schedule based on the selection; and
means for transmitting the execution schedule to a device that schedules instructions on the first and second core.

23. The apparatus of claim 22, wherein the means for splitting is to determine a first complexity of the first partition and a second complexity of the second partition.

24. The apparatus of claim 23, wherein the means for generating is to select the first core based on the first complexity and the second core based on the second complexity.

25. The apparatus of claim 22, wherein the first core is a performance core and the second core is an efficient core.
